(19) United States
(12) Patent Application Publication
(10) Pub. No.: US 2009/0020664 A1
(43) Pub. Date: Jan. 22, 2009

(54) Supporting device and display device using the same

(75) Inventor: Hai-Fang Ma, Suzhou (CN)

Correspondence Address: BACON & THOMAS, PLLC, 625 SLATERS LANE, FOURTH FLOOR, ALEXANDRIA, VA, 22314-1176, US

(73) Assignee: Qisda Corporation, Taoyuan (TW)

(21) Appl. No.: 12/155,861

(22) Filed: Jun. 11, 2008

(30) Foreign Application Priority Data
Jul. 16, 2007 (TW) 96125809

(51) Int. Cl. F16M 13/00

(52) U.S. Cl. 248/158; 248/127

(57) ABSTRACT

A supporting device and a display device using the same are provided. The supporting device is used for supporting the display device. The supporting device includes a first component and a second component. The first component has at least a first through hole. The second component having at least a second through hole includes at least an elasticity unit. The elastic unit is disposed near the second through hole. When the first component is overlapped with the second component, the first through hole is communicated with the second through hole. An inserting unit is inserted in the first through hole and the second through hole. When the inserting unit is inserted into the first through hole and the second through hole, the elastic unit is expanded by the inserting unit to tightly connect to the first through hole for fixing the first component on the second component.

### SUPPORTING DEVICE AND DISPLAY DEVICE USING THE SAME

This application claims the benefit of Taiwan application Serial No. 096125809, filed Jul. 16, 2007, the subject matter of which is incorporated herein by reference.

### BACKGROUND OF THE INVENTION

1. Field of the Invention

The invention relates in general to a supporting device and a display device using the same, and more particularly to a supporting device with quick assembly/detachment mechanism and a display device using the same.

2. Description of the Related Art

Generally, a display panel is supported by one end of a holder, and the other end of the holder is connected to a base which is placed on a desk. The holder and the base are normally engaged together and it is not easy to detach the holder from the base.

FIG. 1 shows a perspective of a base of a conventional supporting structure. FIG. 2 shows a perspective of conventional holder being inserted in the base of FIG. 1. The conventional supporting structure 100 includes a base 110 and a holder 120. The base 110 has two openings 110a, wherein a hook 112 is disposed on the inner wall of the opening 110a. The holder 120 includes a coupling end 122, wherein the coupling end 122 has a slot 122a. As indicated in FIG. 2, the holder 120 is inserted in the opening 110a of the base 110 by the coupling end 122, and the holder 120 is engaged with the hook 112 of the opening 110a by the slot 122a of the coupling end 122.

FIG. 3 shows a perspective of the base engaged with the holder of FIG. 2. The slot 122a of the coupling end 122 is engaged with the hook 112 of the opening 110a, so that the holder 120 is fixed on the base 110 and will not come off easily.

Owing to detach the holder 120 from the base 110, the hook 112 is pulled out form the slot 122a by a force For fixing the holder 120 on the base by an angle without being distorted, both the hook 112 and the slot 122a must be made from rigidity materials, such that the flexible materials are not suitable. Therefore, for detaching the holder 120 from the base, the hook 112 must be pulled out from the slot 122a directly, such that the hook 112 may break easily if too much force applied on the hook 112.

### SUMMARY OF THE INVENTION

The invention is directed to a supporting device and a display device using the same. As the elastic unit is made from an extendable material, the elastic unit is extended to tightly connect with the first through hole for fixing the first component on the second component.

According to a first aspect of the present invention, a supporting device is provided. The supporting device includes a first component, a second component and at least an inserting unit. The first component has at least a first through hole. The second component having at least a second through hole includes at least an elastic unit. The elastic unit is disposed near the second through hole. When the first component is overlapped with the second component, the first through hole is communicated with the second through hole. An inserting unit is inserted in the first through hole and the second through hole. When the inserting unit is inserted into the first through hole and the second through hole, the elastic unit is expanded by the inserting unit to tightly connect to the first through hole for fixing the first component on the second component.

According to a second aspect of the present invention, a display device is provided. The display device includes a display panel and a supporting device. The supporting device for supporting the display panel includes a first component, a second component and at least an inserting unit. The first component has at least a first through hole. The second component having at least a second through hole includes at least an elastic unit. The elastic unit is disposed near the second through hole. When the first component is overlapped with the second component, the first through hole is communicated with the second through hole. An inserting unit is inserted in the first through hole and the second through hole. When the inserting unit is inserted into the first through hole and the second through hole, the elastic unit is expanded by the inserting unit to tightly connect to the first through hole for fixing the first component on the second component.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows a perspective of a base of a conventional supporting structure.

FIG. 2 (Prior Art) shows a perspective of a conventional holder being inserted in the base of FIG. 1.

FIG. 3 (Prior Art) shows a perspective of the base engaged with the holder of FIG. 2.

FIG. 4 shows a perspective of a display device according to a preferred embodiment of the invention.

FIG. 5 shows a perspective of the supporting device according to the first embodiment of the invention.

FIG. 6 shows an exploded diagram of the supporting device of FIG. 5.

FIG. 7 shows a diagram of the second component of the supporting device of FIG. 5.

FIG. 8 shows a diagram of the first component of the supporting device of FIG. 5.

FIG. 9 shows a diagram of an inserting unit of the supporting device of FIG. 5.

FIG. 10 is a partial perspective of the supporting device of FIG. 5.

FIG. 11 is a cross-sectional diagram of the supporting device of FIG. 5.

FIG. 12A shows a diagram of a second component of another elastic unit of FIG. 5.

FIG. 12B is a back view of the second component of FIG. 12A.

FIG. 13 shows a diagram of a supporting device of a second embodiment of the invention.

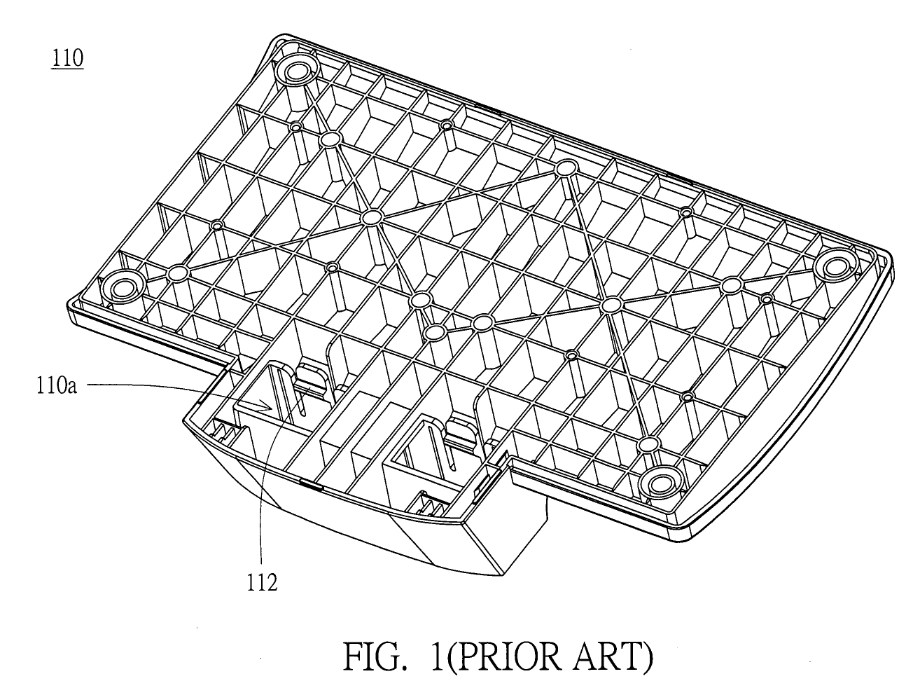

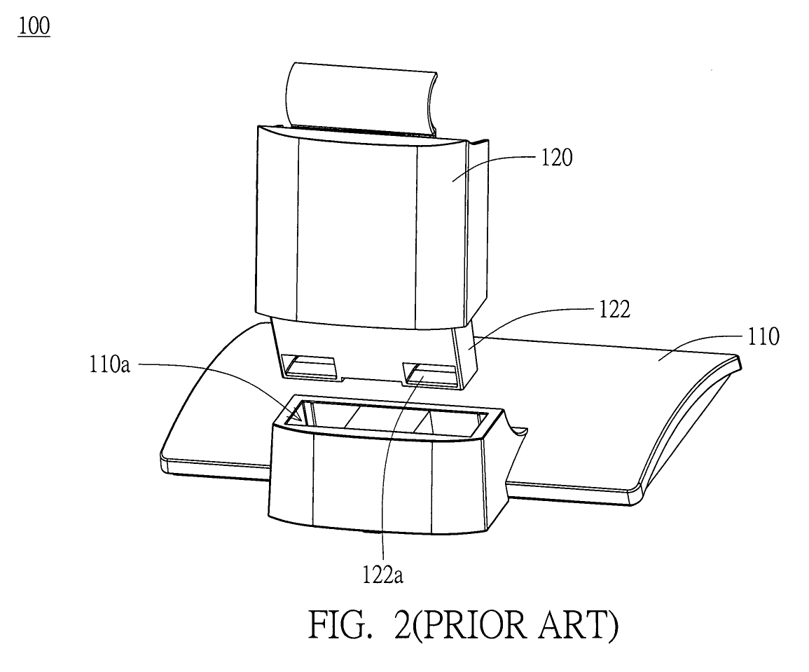

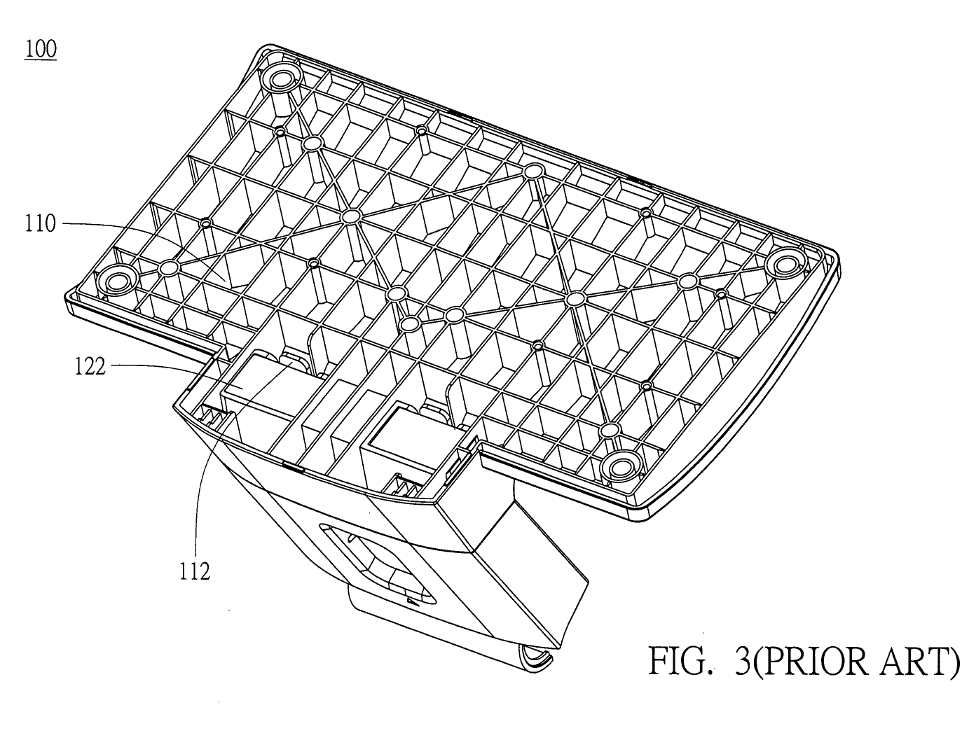

### DETAILED DESCRIPTION OF THE INVENTION

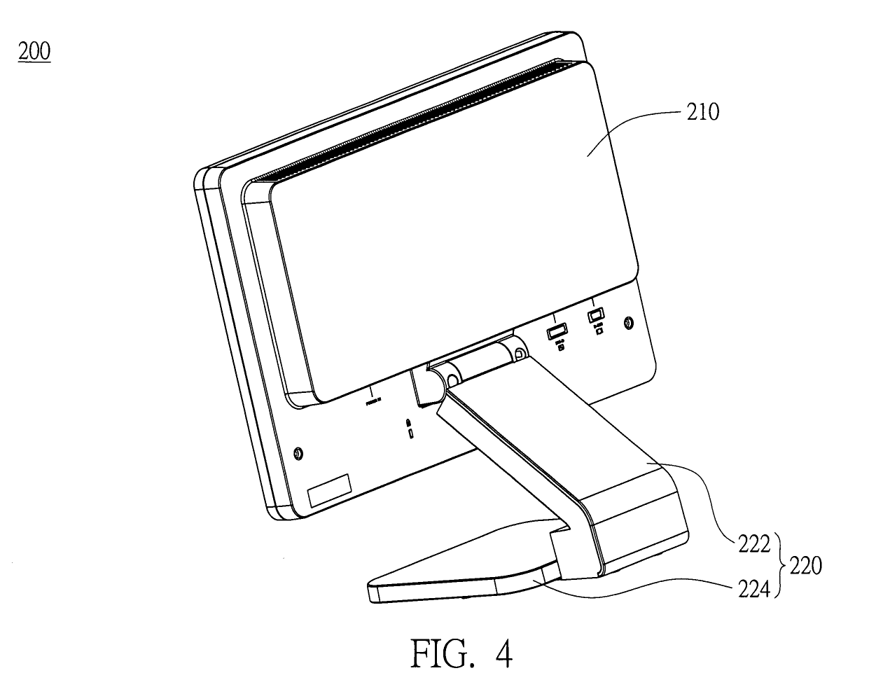

FIG. 4 shows a perspective of a display device according to the preferred embodiment of the invention. The display device 200 includes a display panel 210 and a supporting device 220. The supporting device 220 for supporting the display panel 210 includes a first component 222 and a second component 224. Two embodiments are disclosed below for elaborating the supporting device 220 of the invention not for limiting the scope of protection of the invention.

### First Embodiment

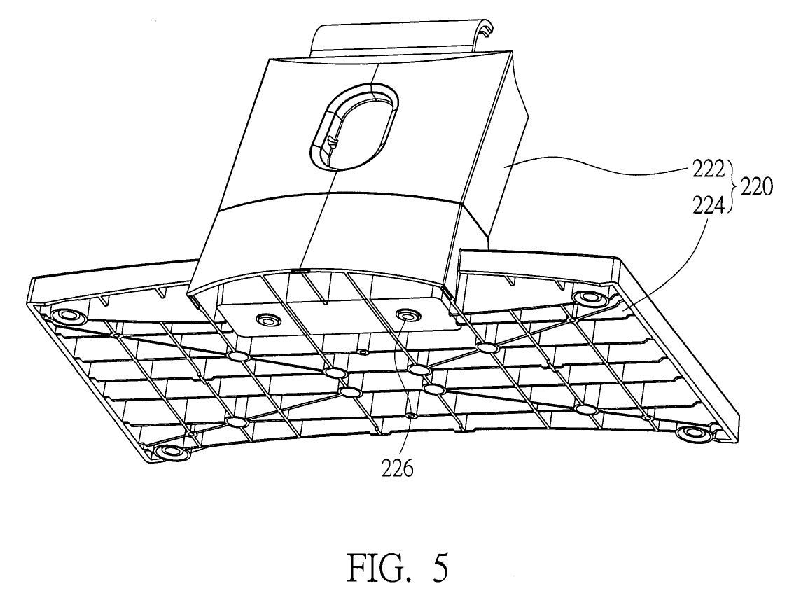

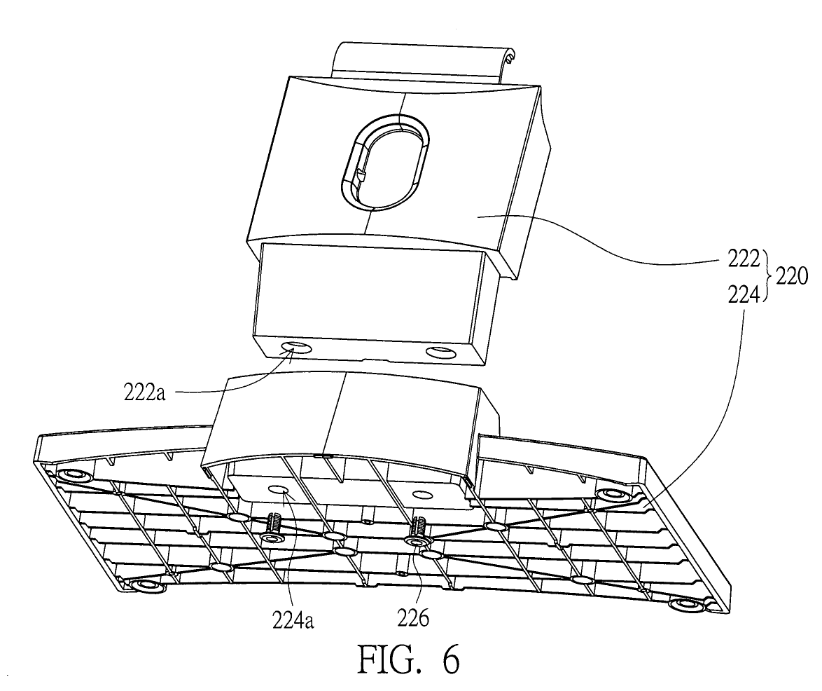

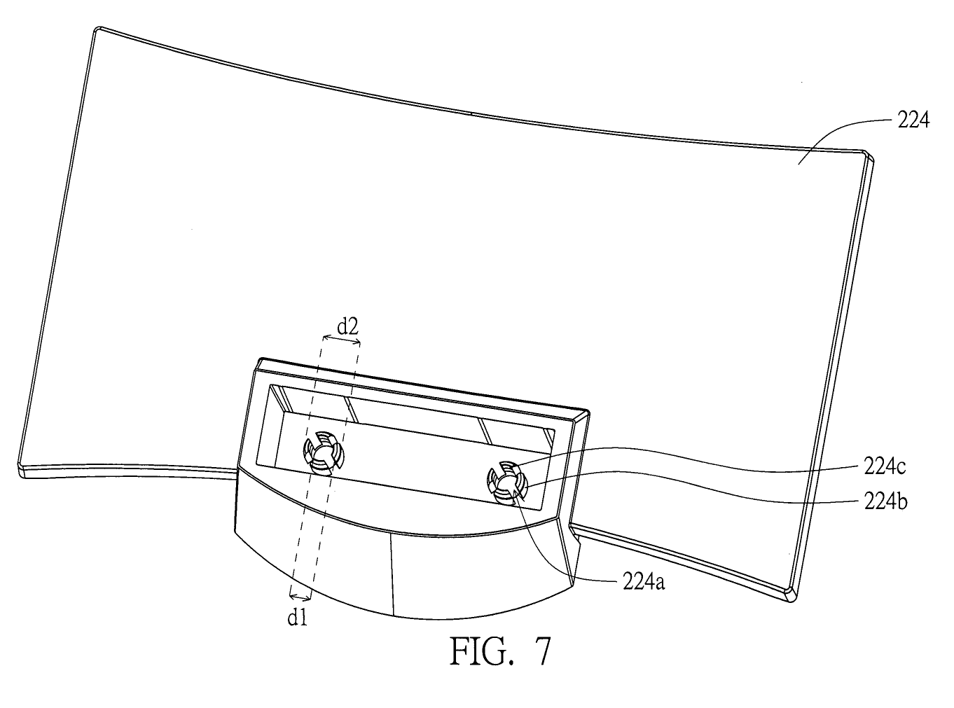

FIG. 5 shows a perspective of the supporting device according to the first embodiment of the invention. FIG. 6 shows an exploded diagram of the supporting device of FIG. 5. The supporting device 220 for supporting the display panel 210 (referring to FIG. 4) includes a first component 222 and a second component 224. In this embodiment, the first component 222 is exemplified as a holder, and the second component 224 is exemplified as a base. The first component 222 has at least a first through hole 222a. The second component 224 having at least a second through hole 224a includes at least an elastic unit 224b, wherein the elastic unit 224b which can not be seen in FIG. 5 and FIG. 6 due to the angle of illustration, and the elastic unit 224b is illustrated in FIG. 7. The elastic unit 224b is disposed near the second through hole 224a. When the first component 222 is overlapped with the second component 224, the first through hole 222a is communicated with the second through hole 224a. The inserting unit 226 is inserted in the first through hole 222a and the second through hole 224a. When the inserting unit 226 is inserted into the first through hole 222a and the second through hole 224a, the elastic unit 224b is expanded by the inserting unit 226 to tightly connect to the first through hole 222a for fixing the first component 222 on the second component 224.

FIG. 7 shows a diagram of the second component of the supporting device of FIG. 5. In the present embodiment, the second component 224 has two second through holes 224a, and the elastic unit 224b is disposed near the second through hole 224a. The elastic unit 224b includes several elastic pieces, which are disposed around the second through hole 224a. The second through hole 224a has a diameter d1, and the elastic unit 224b surrounding the second through hole 224a has an outer diameter d2. It is noted that the elastic pieces are disposed around the second through hole 224a, and the diameter d1 of the second through hole 224a is substantially the same with the inner diameter of the elastic pieces (not labeled). In the present embodiment, the inner wall of the elastic units 224b preferably has an internal thread 224c.

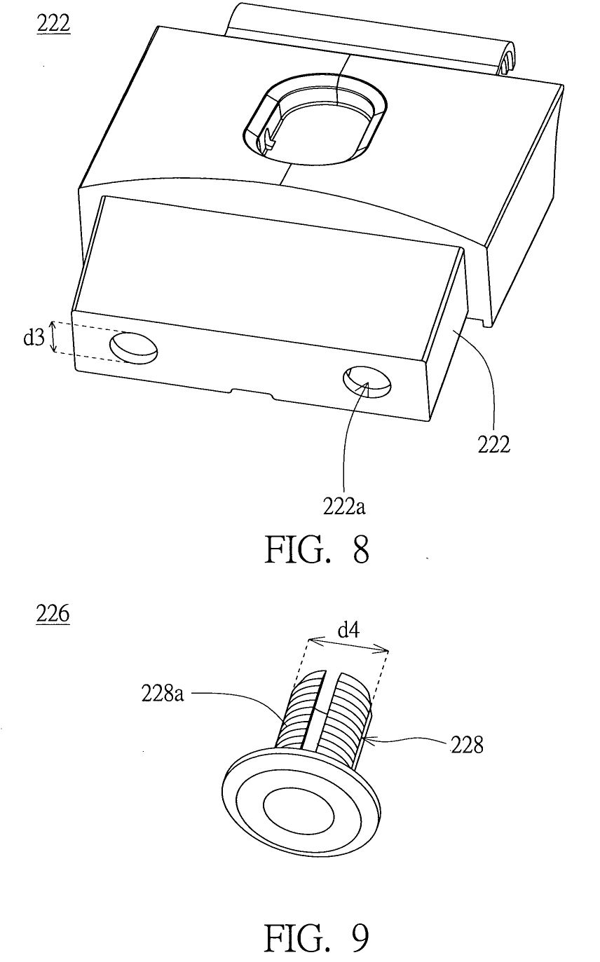

FIG. 8 shows a diagram of the first component of the supporting device of FIG. 5. In the present embodiment, the second component 224 preferably has two second through holes 224a, therefore the first component 222 also has two first through holes 222a wherein the two first through holes 222a respectively corresponding to the two second through hole 224a of the second component 224 dispose on the first component 222. The first through hole 222a has a diameter d3, wherein the diameter d2 of the elastic unit 224b is substantially not equal to the diameter d3 of the first through hole 222a. In the present embodiment, the diameter d3 of the first through hole 222a preferably is slightly larger than the outer diameter d2 of the elastic unit 224b so that the elastic unit 224b of the second component 224 can be easily inserted into the first through hole 222a.

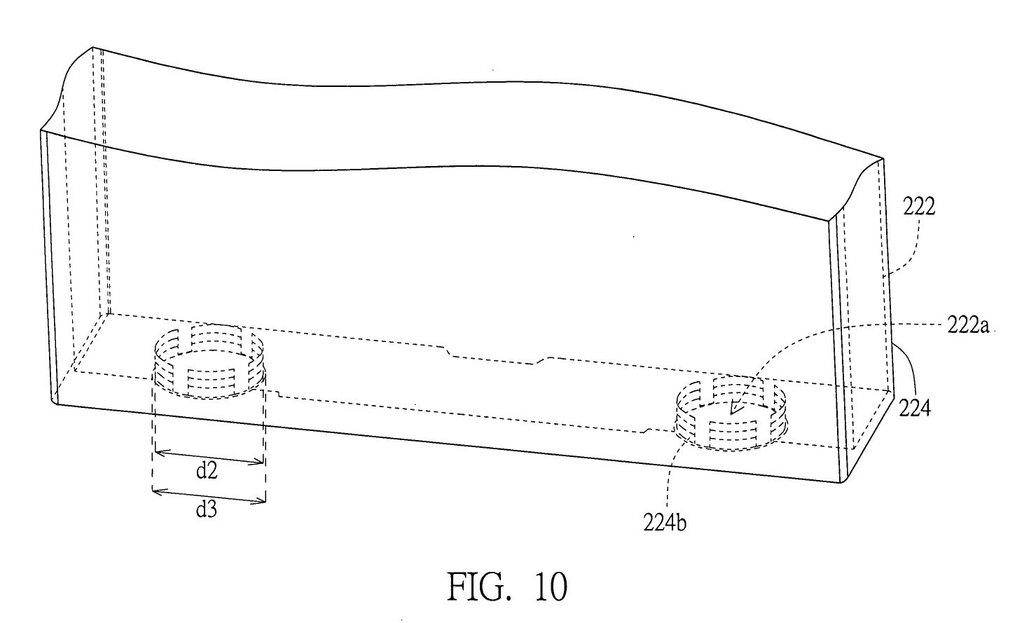

FIG. 9 shows a diagram of an inserting unit of the supporting device of FIG. 5. The inserting unit 226 is disposed corresponded to the elastic unit 224b of the second component 224. The inserting unit 226 includes an inserting end 228, and the inserting end 228 has a diameter d4. In the present embodiment, the diameter d4 of the inserting end 228 is substantially not smaller than the diameter d1 of the second through hole 224a of the second component 224, and the diameter d4 of the inserting unit 226 is substantially larger than the inner diameter of the elastic unit 224b. Therefore, when the inserting unit 226 is inserted into the elastic unit 224b, the elastic unit 224b is expanded by the inserting unit 226 such that the first component 222 is tightly connected to the second component 224. In the present embodiment, the inserting unit 226 preferably has an external thread 228a. The inserting unit 226 is coupled with the elastic unit 224a by engaging the external thread 228a with the internal thread 224c to enhance the friction between the inserting unit 226 and the elastic unit 224b, so that the inserting unit 226 and the elastic unit 224b will not be separated easily. In the present embodiment, the inserting unit 226 can be exemplified as a screw or a rivet without an external thread 228a, and the selection of the inserting unit 226 is determined according to actual needs.

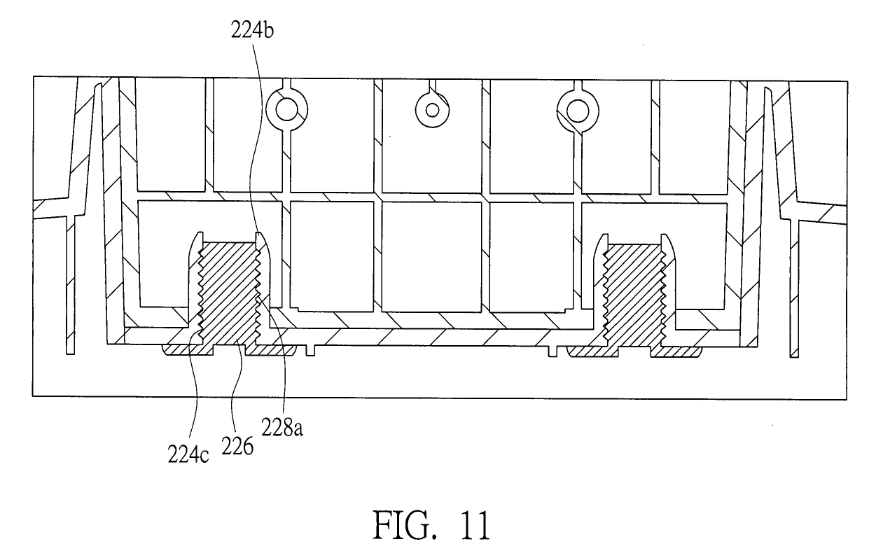

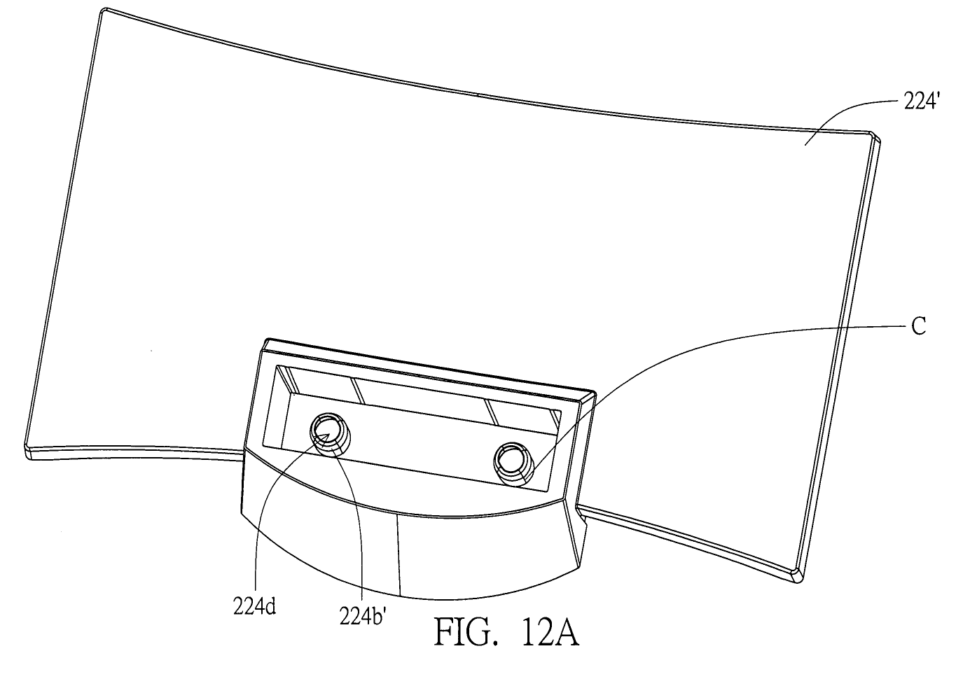

FIG. 10 is a partial perspective of the supporting device of FIG. 5. FIG. 11 is a cross-sectional diagram of the supporting device of FIG. 5. In the present embodiment, the diameter d3 of the first through hole 222a is slightly larger than the outer diameter d2 of the elastic unit 224b, so that the elastic unit 224b can be easily inserted into the first through hole 222a. When the first component 222 is overlapped with the second component 224, the first through hole 222a is communicated with the second through hole 224a. Meanwhile, the inserting unit 226 is inserted into the first through hole 222aand the second through hole 224a, so that the inserting unit 226 contacts with the elastic unit 224b. Preferably, the inserting unit 226 is coupled with the elastic unit 224b by engaging the external thread 228a of the inserting unit 226 with the internal thread 224c of the elastic unit 224b.

As the diameter d4 of the inserting unit 226 is preferably larger than the inner diameter of the elastic unit 224b, the elastic unit 224b is squeezed by the inserting unit 226 to expand outwardly when the inserting unit 226 is inserted in the elastic unit 224b, such that the outer diameter d2 of the elastic unit 224b is expanded. Consequently, the outer diameter d2 of the elastic unit t224b is enlarged to tightly connect to the first through hole 222a for fixing the first component 222 on the second component 224. When the first component 222 is separated from the second component 224, the inserting unit 226 is plugged out or unscrewed for contracting the outer diameter d2 of the elastic unit 224b, so that the separation between the first component 222 and the second component 224 will become easier. Moreover, in the present embodiment, the inserting unit 226 and the elastic unit 224b are coupled by screw-threaded engagement, so the coupling is enhanced and will not become loose easily.

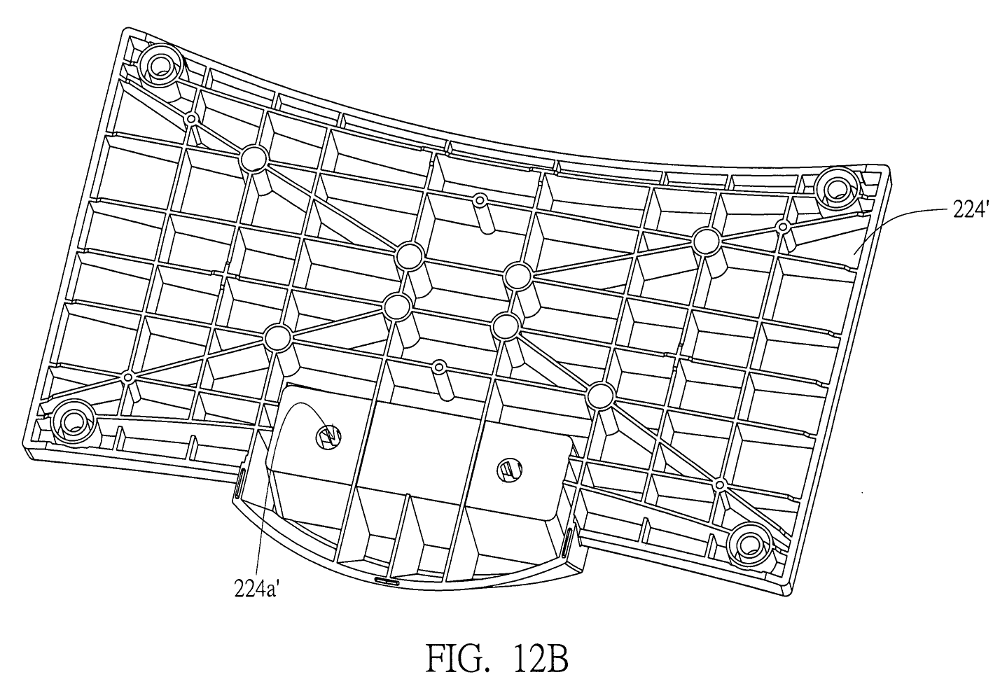

FIG. 12A shows a diagram of a second component of another elastic unit of FIG. 5. FIG. 12B shows a back view of the second component of FIG. 12A. The second component 224″ differs with the second component 224 disclosed above in the structure of the elastic unit 224b″. The elastic unit 224b of the second component 224 is formed by several elastic pieces, but the elastic unit 224b″ being a single elastomer has at least a notch c and a third through hole 224d communicated with the second through hole 224a″.

Similarly, the inserting unit 226 can also be coupled with the elastic unit 224b″ by way of screw-threaded engagement. The elastic unit 224b″ is expanded outwardly by inserting unit 226 to tightly connect to the first through hole 222a for fixing the first component 222 on the second component 224″.

In the present embodiment, two first through holes and two second through holes are incorporated with two inserting units. As the first through holes and the second through holes are both circular holes, the two first through holes and the two second through hole are incorporated with the two inserting units to avoid the wobbling between the first component and the second component. In practical application, if the first through hole and the second through hole are designed to be non-circular and the cross-section of the inserting unit is designed to match the design of the first through hole and the second through hole, then only one single first through hole, one single second through hole and one single inserting unit would be needed.

### Second Embodiment

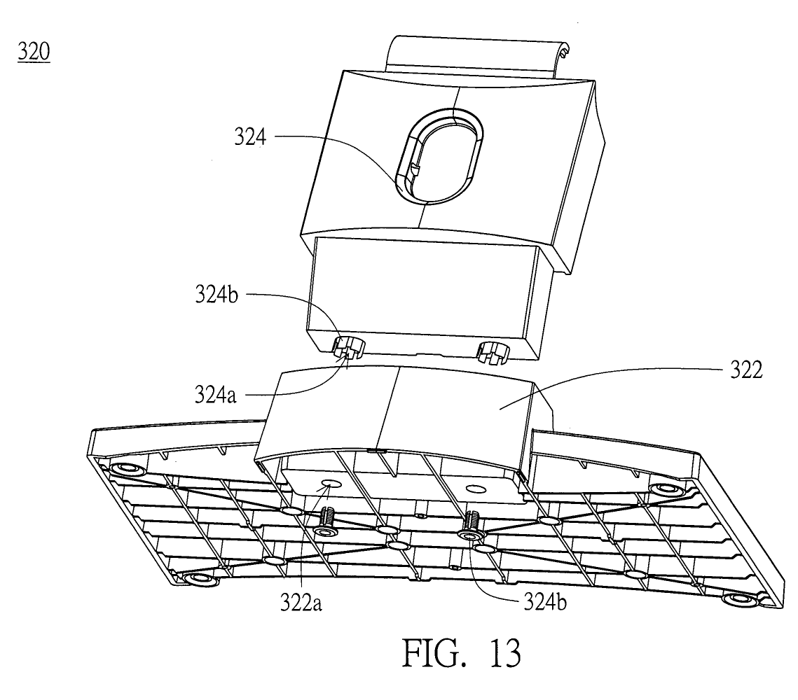

FIG. 13 is a diagram of a supporting device of a second embodiment of the invention. In the first embodiment, the first component 222 is a holder and the second component 224 is a base. The supporting device 320 and a display device using the same of the second embodiment differ with the first embodiment in that the first component 322 of the present embodiment of the invention is a base, the second component 324 is a holder, and other similarities are omitted.

In the present embodiment, the first component 322 is a base, and the second component 324 is a holder. The first component 322 has at least a first through hole 322a. The second component 324 has at least a second through hole 324a and at least an elastic unit 324b. Similarly, the second component 324 is inserted into the first through hole 322a of the first component 322 by the elastic unit 324b to be coupled with the first component 322. In the present embodiment of the invention, the elastic unit 324b of the second component 324 is exemplified as a plurality of elastic pieces, and can be made from an elastic material like the first embodiment.

In the above embodiments, the first component and the second component are exemplified as two sets of through holes and inserting units. It is noted that the number of the through hole and the number of the inserting unit are determined according to actual needs and is not limited.

According to the supporting device and the display device using the same disclosed in the above embodiments of the invention, an elastomer expands and tightly connects with the first through hole for fixing the first component on the second component. Furthermore, the elastomer is coupled with the inserting unit by way of screw-threaded engagement so that the grasp between the elastomer and the inserting unit is enhanced. Through the screw thread, the inserting unit can be quickly detached from the elastomer to make the first component separated from the second component. Such a simply way of assembly and detachment effectively reduces the risk of damaging the supporting device which occurs when the user is assembling or detaching the device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A supporting device, comprising:
a first component having at least a first through hole;
a second component having at least a second through hole, comprising:
at least an elastic unit is disposed near the second through hole, wherein when the first component is overlapped with the second component, the first through hole is communicated with the second through hole; and
at least an inserting unit inserted in the first through hole and the second through hole, wherein when the inserting unit is inserted into the first through hole and the second through hole, the elastic unit is expandable by the inserting unit to tightly connect to the first through hole for fixing the first component on the second component.

2. The supporting device according to claim 1, wherein the elastic unit comprises a plurality of elastic pieces, which are disposed around the second through hole.

3. The supporting device according to claim 1, wherein the elastic unit has at least a notch and a third through hole, and the third through hole is communicated to the second through hole.

4. The supporting device according to claim 1, wherein the elastic unit has an internal thread.

5. The supporting device according to claim 4, wherein the inserting unit has an external thread and the inserting unit is coupled with the elastic unit by engaging the external thread with the internal thread.

6. The supporting device according to claim 1, wherein the diameter of the elastic unit is substantially not equal to the diameter of the first through hole.

7. The supporting device according to claim 6, wherein the diameter of the elastic unit is substantially smaller than the diameter of the first through hole.

8. The supporting device according to claim 1, wherein the inserting unit is a screw.

9. The supporting device according to claim 1, wherein the inserting unit is a rivet.

10. The supporting device according to claim 1, wherein the first component is a holder and the second component is a base.

11. The supporting device according to claim 1, wherein the first component is a base and the second component is a holder.

12. A display device, comprising:
a display panel; and
a supporting device as claimed in claim 1, for supporting the display panel.
